(19) United States
(12) Patent Application Publication
(10) Pub. No.: US 2009/0057436 A1
(43) Pub. Date: Mar. 5, 2009

(54) Portable Water-Based Paint Spray Apparatus and Method of Use

(76) Inventors: Renato J. Valdes, West Roxbury, MA (US); Barry W. Porter, Bridgewater, MA (US)

Correspondence Address: BANNER & WITCOFF, LTD., 28 STATE STREET, 28th FLOOR, BOSTON, MA, 02109-9601, US

(21) Appl. No.: 12/211,858

(22) Filed: Sep. 17, 2008

Related U.S. Application Data
(63) Continuation-in-part of application No. 10/179,088, filed on Jun. 25, 2002.
(60) Provisional application No. 60/974,111, filed on Sep. 21, 2007.

(51) Int. Cl. B05B 9/04; B05B 7/26

(52) U.S. Cl. 239/9; 239/373; 239/310; 239/375; 239/142

(57) ABSTRACT

Disclosed is a portable water-based paint spray apparatus and method of using the same. Argon gas is preferably used both to charge the spray container with pressure and is also used to atomize the water-based paint at the spray receptor.

### CROSS-REFERENCE TO RELATED APPLICATIONS

This application claims priority from commonly owned U.S. Provisional Application Ser. No. 60/974,111, filed Sep. 21, 2007, the disclosure of which is hereby incorporated herein by reference. This application is also a continuation-in-part of commonly owned copending application Ser. No. 10/179,088 filed Jun. 25, 2002, the disclosure of which is hereby incorporated herein by reference.

### BACKGROUND OF THE INVENTION

In U.S. Pat. No. 6,279,837, there is disclosed a reusable chemical caddie (the Enviro Caddie™ commercially available from Enviro Caddie, LLC of Brockton, Mass.). One use of the device is for spraying paint. One drawback of the device is that it cannot be used to spray water-based paints. The present invention rectifies that drawback. The disclosure of this patent is hereby incorporated here by reference.

Chemicals, solvents, and paints are traditionally distributed in aerosol cans, glass bottles, plastic bottles, or metal cans. Aerosol cans offer the advantage of permitting the material to be distributed in a precise flow and pattern, with the disadvantage of high packaging costs and a low amount of material delivered per can. Aerosol cans also tend to be easily misplaced, discarded after only a portion of the contents of the can are dispensed, and these cans are difficult to account for.

The disadvantages of the aerosol can for the dispensing of paint are several. Aerosol cans dispensing paint are very vulnerable to clogging and, unless the valve is purges at the end of use, the paint in the valve dries and renders the can inoperable. To purge the valve at the conclusion of use requires one to turn the can upside down and spray until only the clear propellant comes out. This wastes the propellant and reduces the pressure in the can that is required to spray all of the product inside. Ultimately, the can and remaining product inside is put into the solid waste stream which usually means that the paint, being a hazardous material, goes into the ground.

Many manufacturing and maintenance facilities utilize numerous solvents and paints in the course of their business, and utilize many different methods of distributing and accounting for these chemicals. It is not unusual to find the same solvent or chemical distributed in several different ways, with widely differing costs, in the same facility. These industries have been searching for an economical, environmentally friendly method to dispense various materials that are used within their facilities. Equipment which is safe and which provides a single solution to their needs is now available, through the invention claimed.

Industry has long sought reliable and reusable equipment for dispensing chemicals and paints. Earlier inventors have solved some, but not all, of the problems facing industry. Special purpose equipment is commonplace, but there are few inventions with the flexibility to provide a single solution for dispensing solvents, paints, and other chemicals.

U.S. Pat. No. 1,733,724 provides a tank with an agitator for spraying paint. The lid of the sprayer is held in place by a plurality of bolts, prone to damage, and the unit has no handle, and is thus limited in being easily moved. It is reusable, but not easily labeled, and does not have a safety pressure relief valve, relying instead on a pressure control valve, which if improperly set, would allow the tank to become overly pressurized, and to explode. The agitating member features an integrated motor, as opposed to utilizing an electric drill to agitate the contents as needed. The agitator and dip tubes are exposed upon the removal of the lid, making them prone to damage.

U.S. Pat. No. 1,892,535 discloses a second spray painting system, equipped with a pressure relief valve which is selectively enabled. If the tank is pressurized with the valve in the “off” position, the pressure relief valve would not prevent over pressurization. In addition, the system is stationary, and not suited for dispensing chemicals or paints to their location of use.

U.S. Pat. No. 3,025,006 discloses a third spray painting system on casters for portable use, with a spray nozzle assembly designed to mix pressurized air and paint to propel a fine mist of paint. Pressure of paint fed to the nozzle is not controlled by the system, but rather is monitored by the operator by means of a gauge, and the nozzle is adjusted to compensate for the changes in pressure that occur as the tank is used and the contents are emptied.

Each of these aforementioned patents utilize a fixed motor to operate an agitation mechanism, and are purpose built for dispensing paint. The claimed invention will dispense paint, but it is not limited to dispensing paint, and can be used to dispense solvents or other chemicals. In addition, the claimed invention solves the problem of regulating the output of material so that it is under a consistent pressure, eliminating the need to constantly adjust the flow control valves in traditional paint spraying nozzles.

U.S. Pat. No. 5,785,245 discloses a backpack sprayer for distributing insect eggs in agricultural applications. This invention utilizes a pressurization system that must be engaged as material is distributed, and is purposely built for one specific function. The device utilizes a magnetically coupled agitation device, with a custom motor and a battery to supply power. It features a dispenser that merges compressed air with material to be dispensed.

U.S. Pat. Nos. 5,186,391 and 4,154,401 disclose spray units with self-contained pressurization devices, intended to dispense insecticides in the first instance, and solvents in the second. Neither device is multipurpose enough to permit the dispensing of paint or solvents, but are rather purpose built for a specific purpose. Both devices provide a handle integral to the pressurization device, and neither have a method for stirring the contents.

U.S. Pat. Nos. 4,135,669 and 3,801,015 disclose tanks on wheels with spray nozzles to dispense material under pressure. Neither have a method of stirring the contents. One device has a pressure relief valve, and the other a dedicated compressor. Neither device is suitable for delivering material at a constant pressure over an extended use.

U.S. Pat. Nos. 2,519,707; 888,693; and 587,890 disclose devices that are stationary and designed for a single purpose. None of these inventions lend themselves to a universal solution to the problem of dispensing different materials in an industrial setting.

U.S. Pat. Nos. 3,042,310 and 585,503 disclose devices that dispense a spray of material either under the power of a connected device to supply compressed air, or by generating the pressure within. These devices require adjustments as the pressure supply varies, and are not suitable for dispensing the many products in use in an industrial environment.

The existing devices are designed to solve the problem of dispensing a single material, such as paint, or do not provide the ability to dispense the product under constant pressure for the entire contents in the container. The current art discloses devices that are complicated, with integral motors that could create hazardous situations with sparks, or devices that are not portable. Current devices that are portable enough to permit the device to be lifted and carried are limited, and those commercially available do not provide the features needed to provide a single solution to industry, in order to permit the dispensing of paints, solvents, and other materials.

### SUMMARY OF THE INVENTION

The present invention is directed to a portable water-based paint spray apparatus and method of using the same. For water-based paints, a Noble gas, such as argon gas, is preferably used both to pressurize the spray container and to atomize the water-based paint at the spray receptor for delivery. The present invention provides a rechargeable container and the hand held receptor which allows the replacement of a valve, if clogged, eliminating the problems presented by traditional aerosol cans, and further provides a means for the full delivery of the contents of the sprayer system, eliminating the waste problem common with aerosol cans. The invention provides the following advantages over prior art paint spraying apparatus:
(1) Nearly or completely full evacuation of the contents occurs—no wasted paint like with common spray cans.
(2) Minimal waste occurs—compare that to the typical spray paint can—which clogs and gets thrown away.
(3) Clean or nearly clean when evacuated—most or all of the water-based paint is delivered by the unit—making clean up simple. Also, since the paint is water-based, clean up requires no special solvents.

One embodiment of the present invention is thus directed to an apparatus for spraying a water-based paint comprising:

(a) a pressurizable tank;

(b) a sprayable liquid in said tank; and

(c) a pressurized inert gas in the tank; wherein said gas is used for both liquid delivery and atomization of the liquid; and

(d) an outlet for the atomized water-based paint.

Preferably, the pressurized inert gas is a Noble gas selected from the group comprising argon, helium, neon, krypton, xenon, and radon, or mixtures thereof. More preferably, the pressurized inert gas is argon. Alternatively, the pressurized inert gas comprises a mixture of one or more of the Noble gases with one or more non-Noble gases; for example, a mixture of argon and nitrogen.

Pressurization of the tank will vary depending upon the gases used for pressurization, the thickness of the paint being delivered, the temperature of the delivery, and other similar factors. Typically the gas is pressurized at a pressure of from about 100 to 200 psig. Preferably, the gas is pressurized at a pressure of from about 125 to 150 psig.

A means for mixing the liquid is preferably attached to the tank. This is accessed through a pressurized port—which permits operation of the mixer when the paint is pressurized.

A dispensing means is included with the apparatus. Preferably the dispensing means is a hand held spray receptor comprising:

a cylindrical receptor body with a threaded upper end;

a commercially available vertical action valve assembly; and

a valve locking ring;

wherein:

said valve locking ring threaded to mate with said threaded upper end of said receptor body, and having an opening through which said vertical action valve may extend, configured so that when said valve locking ring is tightened to said threaded upper end of said receptor body;

said vertical action valve is seated firmly to said receptor body, said receptor body configured to receive said vertical action valve into a chamber that is configured to receive said vertical action valve with a minimum of space and volume between said vertical action valve and said receptor body; and

said receptor body having a bore through the center of said cylindrical receptor body from the top to the bottom flat surface, through which a liquid material may be supplied under pressure and dispensed by an operator, through the activation of an actuator on said vertical action valve assembly.

Another embodiment of the present invention is directed to a method of spraying a water-based paint, solvent, or other material, comprising the step of spraying said paint from a portable, reusable, refillable container pressurized with an inert gas. Preferably, the inert gas is Noble gas selected from the group comprising argon, helium, neon, krypton, xenon, and radon, or mixtures thereof. More preferably, the inert gas is argon. Alternatively, the pressurized inert gas comprises a mixture of one or more of the Noble gases with one or more non-Noble gases; for example, a mixture of argon and nitrogen.

The method preferably includes the step of partially filling the tank with a water-based paint, solvent, or other material. The method also preferably includes the step of stirring the water-based paint, solvent, or other material with a mixing means attached to the tank.

Another embodiment of the present invention is directed to an improved apparatus for dispensing paints or chemicals of the type in which a material is loaded into a reusable tank which comprises a dispensing assembly, a pressure relief assembly, a stirring assembly, and a pressurization assembly, wherein the improvement comprises:

using an inert gas selected from the group comprising argon, helium, neon, krypton, xenon, and radon, or mixtures thereof;

thereby permitting the device to pressurize and/or spray water-based paints from the portable unit.

Preferably, the pressurized inert gas is a Noble gas selected from the group comprising argon, helium, neon, krypton, xenon, and radon, or mixtures thereof. More preferably, the pressurized inert gas is argon. Alternatively, the pressurized inert gas comprises a mixture of one or more of the Noble gases with one or more non-Noble gases; for example, a mixture of argon and nitrogen.

### BRIEF DESCRIPTION OF THE DRAWINGS

FIG. 1 illustrates a prior art device, the Enviro Caddie™, as described in U.S. Pat. No. 6,279,837.

FIGS. 2-4 illustrate a handheld spray receptor, as described in pending U.S. patent application Ser. No. 10/179,088, filed Jun. 25, 2002.

FIGS. 5-7 illustrate the components of the present invention, as described in detail below.

### DETAILED DESCRIPTION OF THE INVENTION

The present invention provides a number of improvements to the Enviro Caddie™ device, all of which permit the device to spray water-based paints (as well as the other materials that the product was previously capable of spraying). As described above, this device is described in detail in U.S. Pat. No. 6,279,837, the disclosure of which is incorporated herein by reference. A spray receptor device which is preferably used with the improved version of the Enviro Caddie™ is disclosed in U.S. patent application Ser. No. 10/179,088, filed Jun. 25, 2002, entitled “Handheld Spray Receptor.”

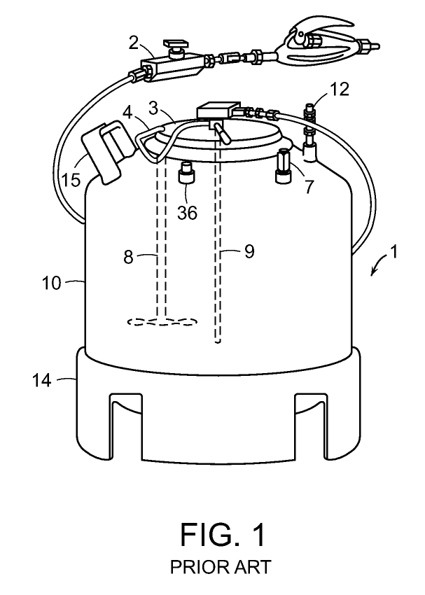

As shown in FIG. 1, the prior art device consists of a stainless steel tank with a removable and resealable lid. An integral stirring mechanism is provided, with a shaft extending beyond the tank, for the attachment of a drill or other power assisted device to turn the stirring shaft. A pressure relief valve is provided, to insure that the tank is not over-pressurized. A stainless steel flexible mesh hose permits the material dispensed to be controlled by a flow control valve, providing precise flow of material. A nozzle and release mechanism permits the dispensed material to be distributed in either a spray or a precise stream. A trigger controls the release mechanism. The mesh reinforced hose permits the operator to position the nozzle by pointing it a surface to receive the dispensed material. A molded plastic sleeve provides an integrated base, handle, and a pocket for placing a label of the tank's contents.

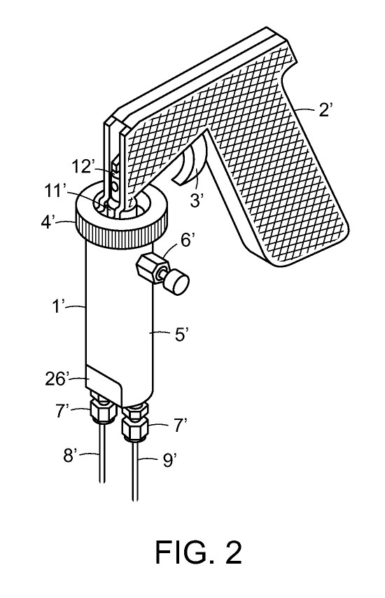

One preferred handheld spray receptor of U.S. Ser. No. 10/179,088 is illustrated in FIGS. 2, 3 and 4. As shown in FIG. 2, the handheld receptor 1′ features a pistol handle assembly 2′ which has a pistol handle trigger 3′, which, when operated with the index finger of an operator presses the actuator 12′ downward, releasing a spray of material dispensed by the handheld receptor 1′. A cylindrical shaped receptor body 5′ utilizes a needle valve assembly 6′ on opposite sides to control the flow of propellant entering through an inlet propellant tubing 8′ through a tubing connector assembly 7′, or controls the flow of dispensed liquid fed to the handheld receptor 1′ through the dispensing liquid tubing 9′ through a tubing connector assembly. An valve locking ring 4′ holds the vertical action valve assembly to the receptor body 5′. Two flat surfaces 26′ are provided to assist in securing the cylindrical receptor body 5′, by means of a wrench or vise, so as to tighten the threaded tubing connector assemblies 7′ to the receptor body 5′. In the preferred embodiment the pistol handle assembly 2′ is a commercially available product constructed of plastic (see U.S. Pat. No. 4,432,474), the vertical action valve assembly 11′ is a standard part as would be employed in the manufacturing of traditional aerosol spray cans, the seals 13′, 16′ are of a material appropriate for the liquid being dispensed. For dispensing paint, a butyl material is preferred; for brake cleaner and penetrant, a buna seal is preferred; Teflon works well for many other liquids, and rubber seals are appropriate for some liquids. The tubing 8′, 9′ is a commercially rated Teflon FEP (fluorinated ethylene propylene), and the remaining parts are machined aluminum. Any material that is either machineable or moldable could be employed to construct the handheld receptor 1′, e.g. plastic, brass or stainless steel.

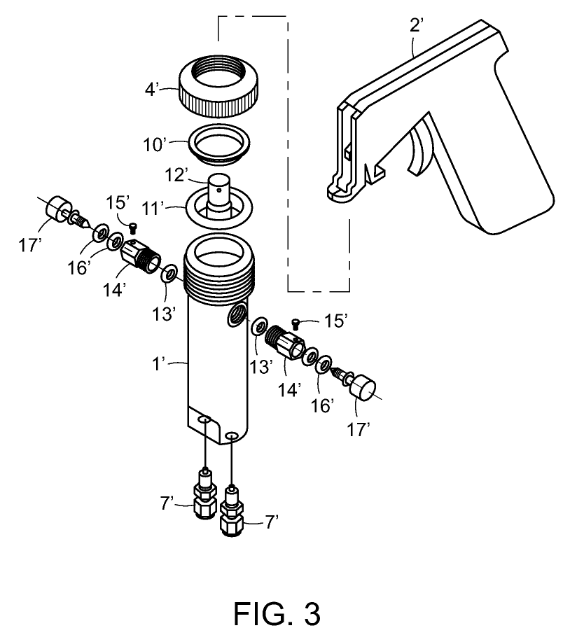

FIG. 3 depicts a perspective isometric view of the handheld spray receptor of FIG. 2, with the optional pistol handle assembly 2′ in place. A receptor body 5′ incorporates an vertical action valve assembly 11′ which provides a actuator 12′ for dispensing liquids. An insert 10′ provides a ridge for attaching the pistol handle assembly 2′. The insert 10′ and vertical action valve assembly 11′ are held in place with the valve locking ring 4′. The receptor body 5′ may be held stationary by means of two parallel flat surfaces 26′ secured with a traditional wrench or vise. Two tubing connector assemblies 7′ provide for the secure attachment of tubing that supplies propellant for purging the actuator 12′, and liquid to be dispensed through the actuator 12′. Valves comprise a needle valve seal 13′ that prevents leakage from the receptor body 5′, a needle valve seat 14′, a detente which prevents the needle valve stem 17′ from being removed completely from the needle valve seat 14′, a needle valve stem seal 16′ that prevents leakage from the needle valve seat 14′, and the needle valve stem 17′.

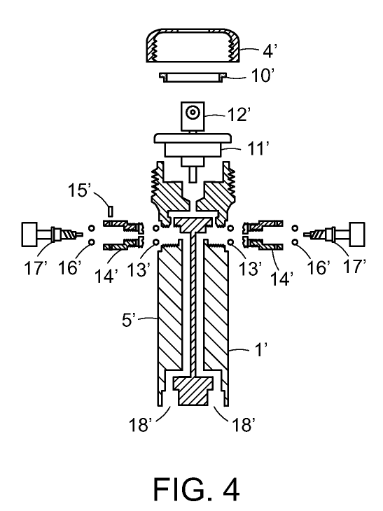

FIG. 4 depicts a cross-section, exploded view of the handheld receptor 1′, without the pistol handle assembly 2′. A receptor body 5′ incorporates an vertical action valve assembly 11′ which provides a actuator 12′ for dispensing liquids. An insert 10′ provides a ridge for attaching the pistol handle assembly 2′. The insert 10′ and vertical action valve assembly 11′ are held in place with the valve locking ring 4′. Valves comprise a needle valve seal 13′ that prevents leakage from the receptor body 5′, a needle valve seat 14′, a detente which prevents the needle valve stem 17′ from being removed completely from the needle valve seat 14′, a needle valve stem seal 16′ that prevents leakage from the needle valve seat 14′, and the needle valve stem 17′. Two threaded tubing connector receptors 18′ permit the attachment of tubing connector assemblies 7′.

The handheld spray receptor provides an apparatus which, when used with a supply of a liquid under pressure, dispenses a liquid material in a pattern that is controlled by an inexpensive and disposable actuator. Such actuators are traditionally employed as an industry standard part that would be found on any aerosol spray can, and feature small cylindrical actuators that may be easily interchanged, so as to provide varied spray patterns. A purging model provides for a quick and convenient method of purging liquid from the actuator, so as to prevent hardening of liquid material exposed to the atmosphere, and a subsequent clogging of the receptor. When used with a supply of liquid under pressure and access to a propellant, the handheld spray receptor significantly reduces the amount of hazardous waste, in the form of partially consumed aerosol cans, that would otherwise enter landfills or hazardous waste recycling facilities.

When used together, the EnviroCaddie™ and the handheld spray receptor have been used commercially for portable spraying applications of non-water based paints and similar materials. The unit is filled with about one gallon of the material to be sprayed and pressurized with a gas such as nitrogen, to 125 psig. The unit is then ready for use as a portable spray device.

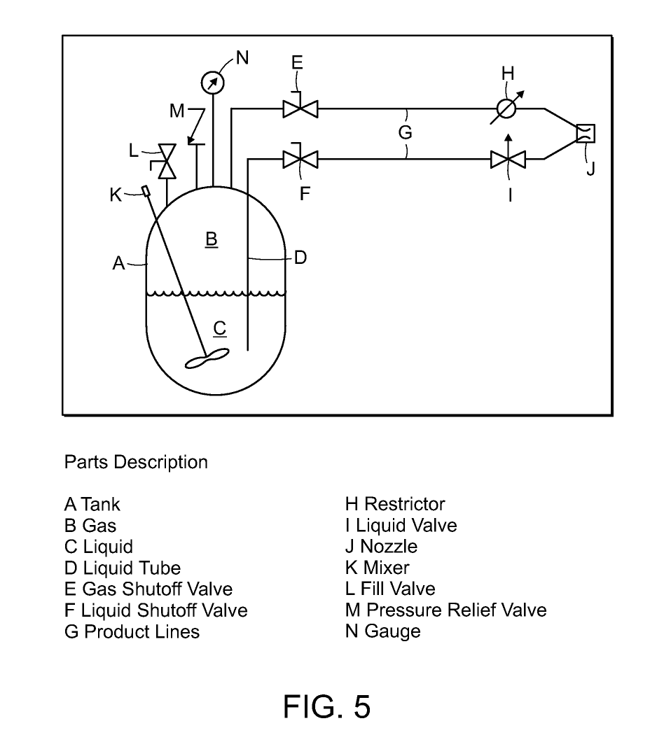

As illustrated in FIG. 5, the improved Enviro Caddie™ spray device preferably includes the all of the following component parts:

the pressurizable tank (A);

a pressurized gas (B);

the liquid to be sprayed by the apparatus (C);

a liquid feed tube (D);

a gas shutoff valve (E);

a liquid shutoff valve (F);

liquid delivery line (G);

gas flow restrictor (H);

liquid flow valve (I);

spray nozzle (J);

mixer (K);

fill valve (L);

pressure relief valve (M); and

pressure gauge (N).

FIG. 5 illustrates the component parts of a preferred embodiment showing the improvements made to the prior art device. As shown therein, gas pressure (B) inside tank (A) pushes the liquid (C) up the tube (D) and through the liquid line to the atomization nozzle (J). A part of the pressurizing gas is diverted through the gas line and through a restriction means (H) to be used to atomize the liquid as it leaves the nozzle. A mixing means (K) is used to keep the liquid(s) mixed or any solids in suspension in the tank. This apparatus allows for the pressurization of water-based paints and the spraying of these paints from this portable unit. There are no volatile propellants used. Instead, a non-reactive gas or mixture of such gases, can be used. Preferably, such non-reactive gases include, but are not limited to, the Noble gases—helium, neon, argon, krypton, xenon, and radon—or mixtures thereof. In certain preferred embodiments, argon gas has been found to be especially useful for spraying water-based paints.

The component parts shown in FIG. 5 are those employed in the currently preferred embodiment of the invention. Many of these parts can be modified or eliminated, so long as the following essential parts are retained; (1) the pressurizable tank; (2) a sprayable liquid in the tank; (3) a pressurized gas in the tank used for both liquid delivery and atomization of the liquid at the outlet end.

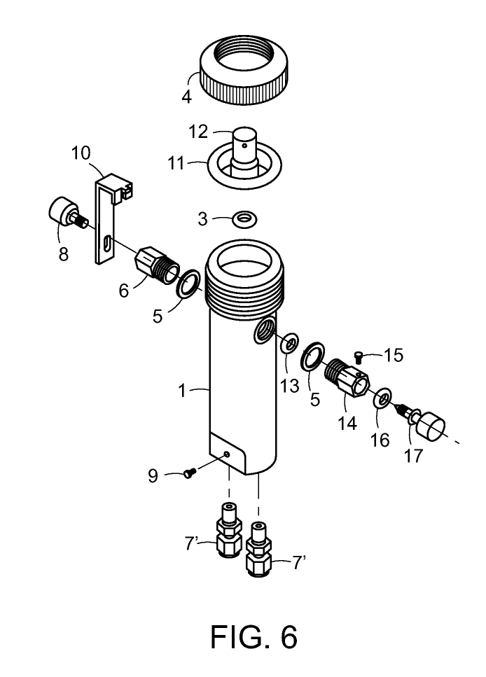

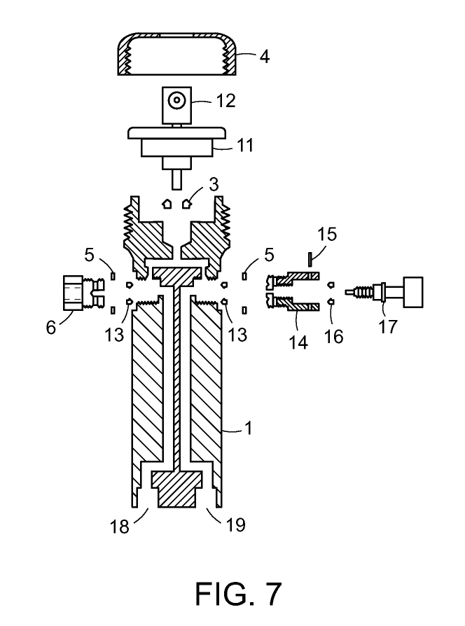

FIGS. 6 and 7 illustrate improvements made to the spray receptor of U.S. patent application Ser. No. 10/179,088. While many of the parts have been retained from the earlier described embodiment, an insert (10′) and one of the needle valves (17′) have been eliminated, simplifying the operation of the device. In place of the insert, a retainer clip (gun lock) has been added to secure the spray handle. The parts shown are identified as follows; 1—Receptor Body; 3—Vertical Action Valve Seal; 4—Locking Ring; 5—Copper Washer; 6—Gas Chamber Plug; 7—Tube Fittings; 8—Gun Lock Screw; 9—Cable Locking Screw; 10—Gun Lock; 11—Vertical Action Valve; 12—Actuator; 13—Teflon Washer; 14—Valve Body; 15—Valve Stem Locking Screw; 16—Valve Stem Seal; 17—Valve Stem; 18—Gas Port; and 19—Paint Port.

In the preferred method of the present invention, a water-based paint is added to a three gallon tank, filling the tank about (30%). Argon gas is used to pressurize the tank to about 125-150 psig depending upon the water-based paint's viscosity (higher viscosity requires higher pressure). The water-based paint is stirred with the mixer to ensure complete suspension of the paint solids in the water solvent. The gas shutoff valve is opened; the liquid shutoff valve is opened; and the liquid valve and restrictor valve are both adjusted to provide a desired spray volume and velocity at the nozzle. The unit is then ready for use as a portable water-based paint spray apparatus.

What is claimed is:

1. An apparatus for spraying a water-based paint comprising:
(a) a pressurizable tank;
(b) a sprayable liquid in said tank; and
(c) a pressurized inert gas in the tank; wherein said gas is used for both liquid delivery and atomization of the liquid; and
(d) an outlet for the atomized water-based paint.

2. The apparatus of claim 1, wherein the pressurized inert gas is a Noble gas selected from the group comprising argon, helium, neon, krypton, xenon, and radon, or mixtures thereof.

3. The apparatus of claim 2, wherein the pressurized inert gas is argon.

4. The apparatus of claim 2, wherein the pressurized inert gas further comprises a mixture of one or more of the Noble gases with one or more non-Noble gases.

5. The apparatus of claim 4, wherein the pressurized inert gas is a mixture of argon and nitrogen.

6. The apparatus of claim 3, wherein the gas is pressurized at a pressure of from about 100 to 200 psig.

7. The apparatus of claim 6, wherein the gas is pressurized at a pressure of from about 125 to 150 psig.

8. The apparatus of claim 3, wherein a means for mixing the liquid is attached to said tank.

9. The apparatus of claim 3, wherein the dispensing means is a hand held spray receptor comprising:
a cylindrical receptor body with a threaded upper end;
a commercially available vertical action valve assembly; and
a valve locking ring;
wherein:
said valve locking ring threaded to mate with said threaded upper end of said receptor body, and having an opening through which said vertical action valve may extend, configured so that when said valve locking ring is tightened to said threaded upper end of said receptor body;
said vertical action valve is seated firmly to said receptor body, said receptor body configured to receive said vertical action valve into a chamber that is configured to receive said vertical action valve with a minimum of space and volume between said vertical action valve and said receptor body; and
said receptor body having a bore through the center of said cylindrical receptor body from the top to the bottom flat surface, through which a liquid material may be supplied under pressure and dispensed by an operator, through the activation of an actuator on said vertical action valve assembly.

10. A method of spraying a water-based paint, solvent, or other material, comprising the step of spraying said paint from a portable, reusable, refillable container pressurized with an inert gas.

11. The method of claim 10, where the inert gas is Noble gas selected from the group comprising argon, helium, neon, krypton, xenon, and radon, or mixtures thereof.

12. The method of claim 11, wherein the inert gas is argon.

13. The method of claim 10, further comprising the step of partially filling the tank with a water-based paint, solvent, or other material.

14. The method of claim 10, further comprising the step of stirring the water-based paint, solvent, or other material with a mixing means attached to the tank.

15. An improved apparatus for dispensing paints or chemicals of the type in which a material is loaded into a reusable tank which comprises a dispensing assembly, a pressure relief assembly, a stirring assembly, and a pressurization assembly, wherein the improvement comprises:
using an inert gas selected from the group comprising argon, helium, neon, krypton, xenon, and radon, or mixtures thereof; thereby permitting the device to pressurize and/or spray water-based paints from the portable unit.

16. The improved dispensing apparatus of claim 15, wherein the inert gas is argon.
